(19) United States
(12) Patent Application Publication
(10) Pub. No.: US 2023/0130010 A1
(43) Pub. Date: Apr. 27, 2023

(54) AUTOMATED CONTENT QUALITY CONTROL

(71) Applicant: NBCUNIVERSAL MEDIA, LLC, Universal City, CA (US)

(72) Inventor: Jason Rayles, Brookline, MA (US)

(73) Assignee: NBCUNIVERSAL MEDIA, LLC, Universal City, CA (US)

(21) Appl. No.: 17/817,798

(22) Filed: Aug. 5, 2022

Related U.S. Application Data
(60) Provisional application No. 63/270,934, filed on Oct. 22, 2021.

(51) Int. Cl. G10L 25/60; G10L 25/18; G10L 25/57; G06T 11/00

(52) U.S. Cl. CPC G10L 25/60; G10L 25/18; G10L 25/57; G06T 11/001

(57) ABSTRACT

Systems and methods for providing an environment for comparing a first audio content with a second audio content are disclosed. According to at least one embodiment, a method for comparing a first audio content with a second audio content includes: obtaining a first spectrogram representing the first audio content; obtaining a second spectrogram representing the second audio content; generating a combined spectrogram based on the first spectrogram and the second spectrogram; and determining whether the first audio content is misaligned with respect to the second audio content based on the combined spectrogram.

### CROSS-REFERENCE TO RELATED APPLICATION(S)

Pursuant to 35 U.S.C. § 119(e), this application claims the benefit of U.S. Provisional Patent Application Ser. No. 63/270,934, filed on Oct. 22, 2021, the contents of which are hereby incorporated by reference herein in their entirety.

### BACKGROUND

Promotional content (or promos) may be generated to promote particular television content (e.g., a particular TV show). The promos are generated to be broadcast (e.g., during broadcast of another TV show) on a particular day or week. Some promos, referred to as straight promos, do not feature information indicating when and where the promoted show will be broadcast. In contrast, other promos do feature such information.

For example, such information may be featured in the promo at an end page of the promo. An end page includes a sequence of video frames. The video frames indicate when and/or on what station the promoted show will be broadcast. For example, in addition to a displayed graphic, the video frames may include audio providing such indication(s).

FIG. 1 shows a screen capture 100 of a frame of an example end page of an example promo. The frame may be accompanied by audio (e.g., voiceover audio) that states, by way of example, “Catch Rachael tomorrow at 2 PM on NBC 10 Boston.”

The end page of FIG. 1 may be similar to end pages of other promos that promote the same TV show. Such other promos may be the same as the promo of FIG. 1, except that such other end pages may feature information indicating, by way of example, a different station and/or a different time of day at which the promoted show will be broadcast. For example, such other promos and the promo of FIG. 1 may all be based on a common promo (e.g., a generic promo). However, each promo may have been edited to feature a different end page that is customized, for example, for a target broadcast area.

### SUMMARY

Such editing of a common promo to generate customized promos may be performed by human operators. This process may be tedious and prone to human error. This process may be very time-consuming when performed to generate large numbers of customized promos.

Aspects of the present disclosure are directed to comparing first audio content (e.g., of audiovisual content of a reference end page) with second audio content (e.g., of audiovisual content of a promo that includes an end page) in a more autonomous manner. Based on the comparison, it is determined whether a specific reference end page is associated with a specific promo end page. According to a further aspect, the comparison includes determining a degree to which particular audio content included in the promo end page is present in the specific reference end page. The particular audio content may include specific voiceover content that would be found in a reference end page that properly corresponds to the promo end page. Although aspects of the present disclosure illustrate techniques of audio comparison within the context of end pages and promos, the audio comparison techniques described may be applied more generally to any audio files and contexts in order to compare the audio content between two sources.

According to at least one embodiment, a method for comparing a first audio content with a second audio content includes: obtaining a first spectrogram representing the first audio content; obtaining a second spectrogram representing the second audio content; generating a combined spectrogram based on the first spectrogram and the second spectrogram; and determining whether the first audio content is misaligned with respect to the second audio content based on the combined spectrogram.

According to at least one embodiment, a machine-readable non-transitory medium has stored thereon machine-executable instructions for comparing a first audio content with a second audio content. The instructions include: obtaining a first spectrogram representing the first audio content; obtaining a second spectrogram representing the second audio content; generating a combined spectrogram based on the first spectrogram and the second spectrogram; and determining whether the first audio content is misaligned with respect to the second audio content based on the combined spectrogram.

According to at least one embodiment, an apparatus for comparing a first audio content with a second audio content includes: a network communication unit configured to transmit and receive data; and one or more controllers. The one or more controllers are configured to: obtain a first spectrogram representing the first audio content; obtain a second spectrogram representing the second audio content; generate a combined spectrogram based on the first spectrogram and the second spectrogram; and determine whether the first audio content is misaligned with respect to the second audio content based on the combined spectrogram.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects and features of the present disclosure will become more apparent upon consideration of the following description of embodiments, taken in conjunction with the accompanying drawing figures.

FIG. 1 shows a screen capture of a frame of an example end page.

FIG. 2 illustrates example naming conventions that may be adopted in generating names of reference end pages and that of a promo end page.

FIG. 3 illustrates a flow diagram of generating reference information according to at least one embodiment.

FIG. 4 illustrates a flow diagram of a process (e.g., quality control process) that includes comparing at least one reference end page with a promo end page according to at least one embodiment.

FIG. 5 illustrates calculation of a structural similarity index measure (SSIM) index between windows x and y having common dimensions.

FIGS. 6(a), 6(b) and 6(c) illustrate example spectrograms of audio content of a reference end page.

FIG. 7 illustrates an example of aligning a spectrogram of audio content in the reference end page with a spectrogram of audio content in the promo end page according to at least one embodiment.

FIGS. 8(a) and 8(b) illustrate examples of combined spectrograms.

FIGS. 9(a), 9(b), 9(c), 9(d) and 9(e) illustrate examples of combined spectrograms.

FIG. 10 illustrates a flowchart of a method of comparing audio content according to at least one embodiment.

FIG. 11 is an illustration of a computing environment according to at least one embodiment.

FIG. 12 is a block diagram of a device according to at least one embodiment.

### DETAILED DESCRIPTION

In the following detailed description, reference is made to the accompanying drawing figures which form a part hereof, and which show by way of illustration specific embodiments of the present invention. It is to be understood by those of ordinary skill in this technological field that other embodiments may be utilized, and that structural, as well as procedural, changes may be made without departing from the scope of the present invention. Wherever possible, the same reference numbers will be used throughout the drawings to refer to the same or similar parts.

As described earlier, one or more human operators may edit a common promo to generate customized promos. For example, upon receiving a common promo, one or more editors may identify (e.g., from among a set of reference end pages), a reference end page that is associated with the received common promo. The set of reference end pages is used to classify an incoming promo. For example, the reference end pages embody information including information indicating a show with which the promo is to be broadcast, information indicating a station (e.g., network affiliate) on which the promo is to be broadcast, information indicating day and time of the broadcast, etc.

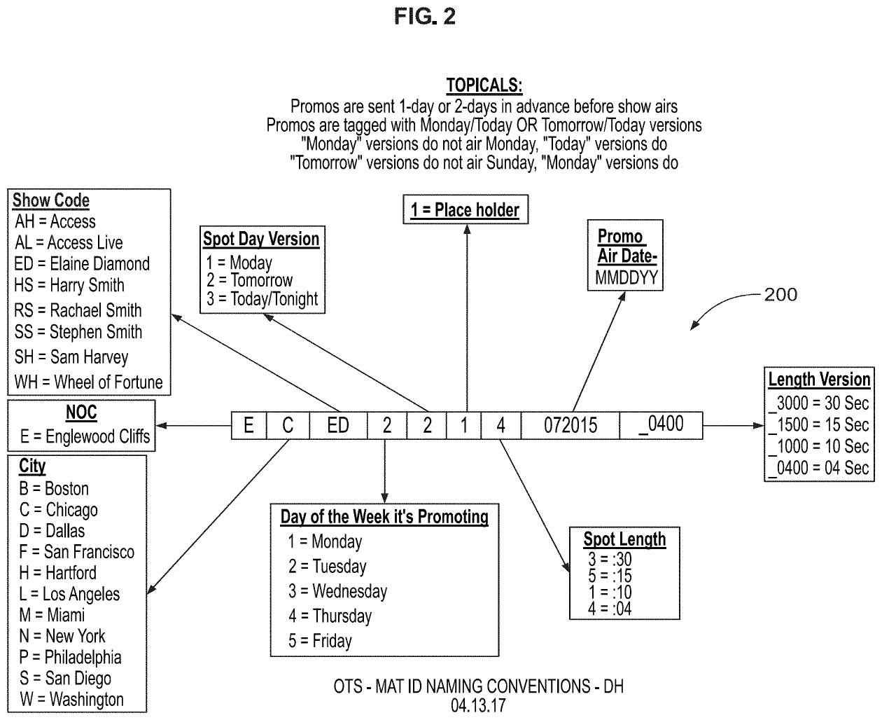

FIG. 2 illustrates example naming conventions that may be adopted in generating a name (e.g., file name) of a reference end page or a promo end page. As illustrated in FIG. 2, a generated name 200 is composed of multiple fields. For example, one field carries information indicating a city in which the (associated) promo is to be broadcast. As another example, another field carries information indicating the show with which the promo is to be broadcast. As yet another example, another field carries information indicating a day in which the promo is to be broadcast (e.g., tomorrow, today, etc.). As such, the name of a reference end page may be generated to carry such information.

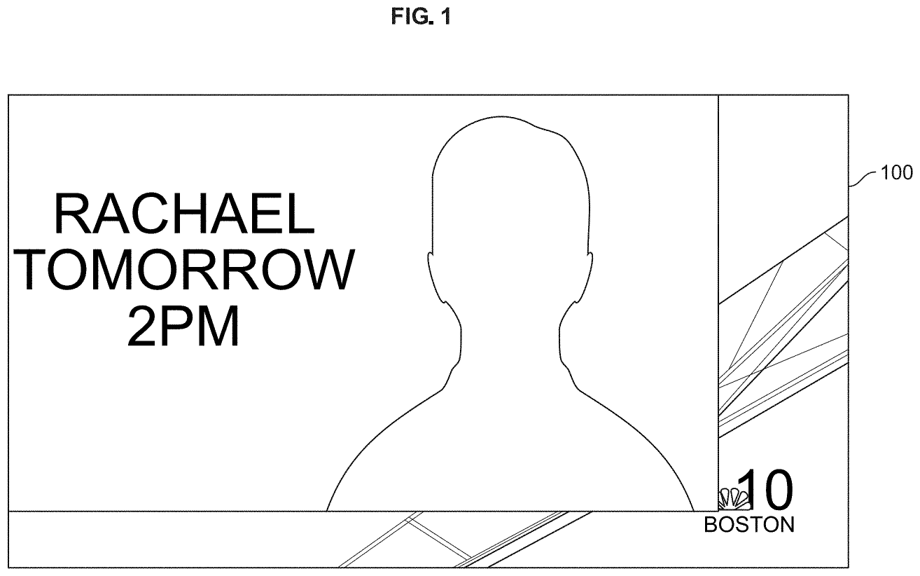

Similarly, the name of a promo (e.g., a promo including an end page) may be generated to carry such information. Accordingly, analyzing the name of a promo may be utilized to validate that an end page (e.g., an identified reference end page) that is (or has been) edited into a promo corresponds to the promo. By way of example, analyzing the name of the promo may be used to validate that an identified reference end page includes the frame illustrated in the screen capture 100. As illustrated in FIG. 1, the frame illustrated in the screen capture 100 is for promoting that a particular show is to be broadcast the following day (i.e., “TOMORROW”), and not to be broadcast on the current day (i.e., “TODAY”).

As will be described in more detail herein, aspects of the present disclosure are directed to validating that an end page that is (or has been) edited into a promo correctly corresponds to a given promo (e.g., correctly corresponds to the target of a given promo). For example, one or more embodiments are directed to verifying that an end page that is (or has been) appended to a promo is correctly associated with a given promo based on comparing aspects of the reference end page with aspects of the promo end page. For example, it is verified that the reference end page is associated with a corresponding TV show or program, has an appropriate length with respect to time, and/or corresponds to announcing broadcast of a TV show or program on a particular day, time and/or network. Further by way of example, it is determined whether audio content included in the promo end page is present in the reference end page. The audio content may include specific voiceover content that would be found in a reference end page that properly corresponds to the promo end page.

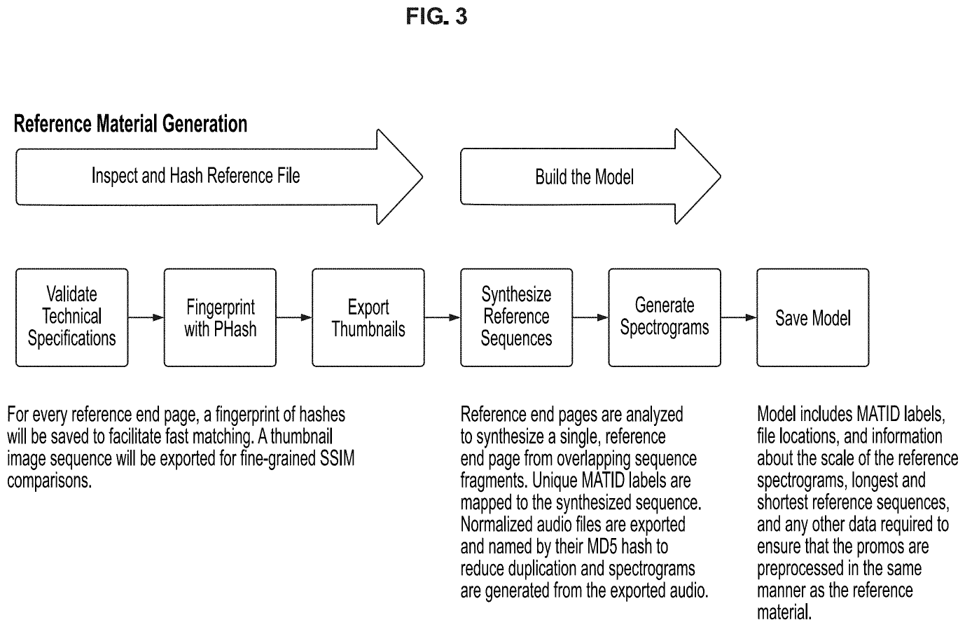

FIG. 3 illustrates a flow diagram of generating reference information according to at least one embodiment. The reference information includes hashes corresponding to respective reference end pages and/or thumbnail images of one or more frames of each reference end page. For example, referring to FIG. 3, technical specifications may be validated for the reference end page, and subsequently, the reference end page may be hashed (e.g., using a perceptual hash), and a fingerprint of the hash for various reference end pages may be saved to facilitate fast matching. A thumbnail image sequence of the reference end page may be exported for fine-grained SSIM comparisons later. In an aspect, the reference information may also include spectrogram information corresponding to respective end pages.

Optionally, the reference end pages may be analyzed to synthesize a single, reference end page from overlapping sequence fragments. Unique MATID labels are mapped to the synthesized sequence. Normalized audio files are exported and named by their MD5 hashes to reduce duplication and spectrograms may be generated from the exported audio. In an aspect, the model may include MATID labels, file locations, and information about the scale of the reference spectrograms, longest and shortest reference sequences, and any other data required to ensure that the promos are preprocessed in the same manner as the reference material.

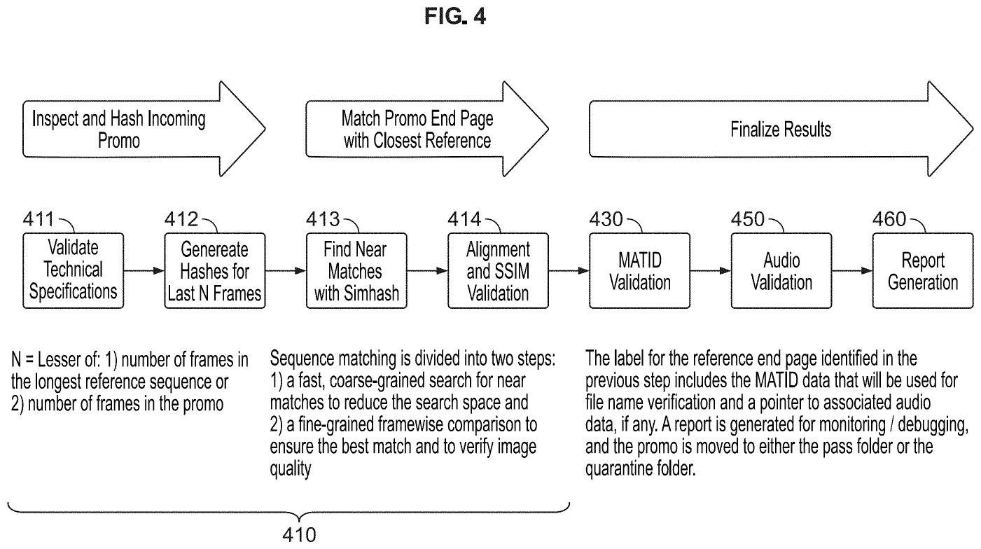

As will be described in more detail later with reference to FIG. 4, the reference information may be used in a process (e.g., quality control process) that is performed for a promo end page.

Generating reference information, as illustrated in FIG. 3, may occur periodically, e.g., once every six months or weekly. For example, reference information may be generated based on a most recent batch of reference end pages and/or a group of reference end pages that are known.

FIG. 4 illustrates a flow diagram of a quality control process that includes comparing at least one reference end page with a promo end page according to at least one embodiment. As will be described in more detail herein, the process may include a video validation 410 and/or an audio validation 450. If the process includes performing both validations 410 and 450, the video validation 410 and the audio validation 450 may be performed independent of each other, simultaneously, or in series. Although FIG. 4 illustrates the video validation 410 as occurring before the audio validation 450, that order may be switched, such that the audio validation 450 is performed before the video validation 410. Also, it is understood that, if a particular validation (e.g., the video validation 410) either fails or results in a non-match, then performance of other validations (e.g., the audio validation 450) may be omitted. For example, other validations may be omitted for purposes of saving time and/or reducing effort.

The video validation 410 will now be described in more detail with reference to at least one embodiment.

At block 411, certain technical specifications (or parameters) of the promo may be validated against corresponding specifications of a reference end page, to determine whether the specifications are aligned. Such technical specifications may include frames per second (FPS), pixel resolution, audio frequency, etc. According to at least one embodiment, software tools may be used to identify metadata such as the frame rate, dimensions, etc. of the promo. Similarly, technical specifications (or parameters) of a reference end page may be validated against corresponding specifications of the promo.

At block 412, a hash of the promo is generated. According to at least one embodiment, the hash may be generated based on perceptual hashing. Perceptual hashing is used to determine whether features of particular pieces of multimedia content are similar, e.g., based on, image brightness values of individual pixels.

As illustrated in FIG. 4, hashes for the last N frames of the promo may be generated, where N denotes an integer that is equal or greater than 1. In this regard, the last N frames may correspond to a length of time. In another aspect, N may correspond to the lesser of (1) the number of frames in the longest reference sequence or (2) the number of frames in the promo. For example, it may be determined that the longest acceptable length of an end page may be around 8 seconds. In this situation, if the total length of a promo is 30 seconds, then N may be equal to the number of frames in the last 8 seconds of the promo, which is where the end page is located. Here, it is understood that, if the total length of the promo is shorter than the longest acceptable length of an end page, then N may be equal to the total number of frames in the promo. For example, if the total length of the promo is 4 seconds (and is, therefore, shorter than the longest acceptable length of 8 seconds), then N may be equal to the total number of frames in the 4-second promo.

Hashes of the reference end pages (see FIG. 3) may be generated in a similar manner. Accordingly, a hash of the promo may be compared against a hash of a reference end page, as will be described in more detail below.

At blocks 413 and 414 of FIG. 4, the promo is compared with at least one reference end page based on information described earlier, e.g., hash information. For example, at block 413, a hash of the last frame of the promo may be retrieved. Then, all reference end pages that have a hash that is within a particular Hamming distance threshold (relative to the hash of the last frame of the promo) are identified. For each reference end page that meets such a threshold, a finer-grained analysis may then be performed (see block 414).

At block 413, it may be determined whether each of a number of ordered frames (e.g., N ordered frames) of the promo end page is sufficiently similar to a corresponding frame of the reference end page. The degree of similarity may be based on Hamming distance. For a given pair of end pages, it may be determined that the two end pages are sufficiently similar if, for each of the N frames, the difference between respective hashes does not exceed the Hamming distance threshold. For example, the Hamming distance threshold may be an integer between 0 and 3, inclusive.

Accordingly, the coarser-grained analysis of block 413 may result in identification of one or more reference end pages that potentially match the promo end page. As such, the search space of potential matches is likely reduced (or narrowed) based on perceptual hashing. A finer-grained analysis is then performed based on an accordingly smaller number of reference end pages.

At block 414, a finer-grained analysis is performed to further measure the similarity between respective frames of end pages (e.g., respective frames of a promo end page and a reference end page identified at block 413). According to at least one embodiment, the analysis of block 414 is based on a structural similarity index measure (SSIM). In sum, sequence matching (or reference and promo end page matching) may be divided into two steps. First, a fast, coarse-grained search for near matches to reduce the search space may be performed. Second, a fine-grained framewise comparison (e.g., SSIM) may be performed to ensure the best match and to verify image quality.

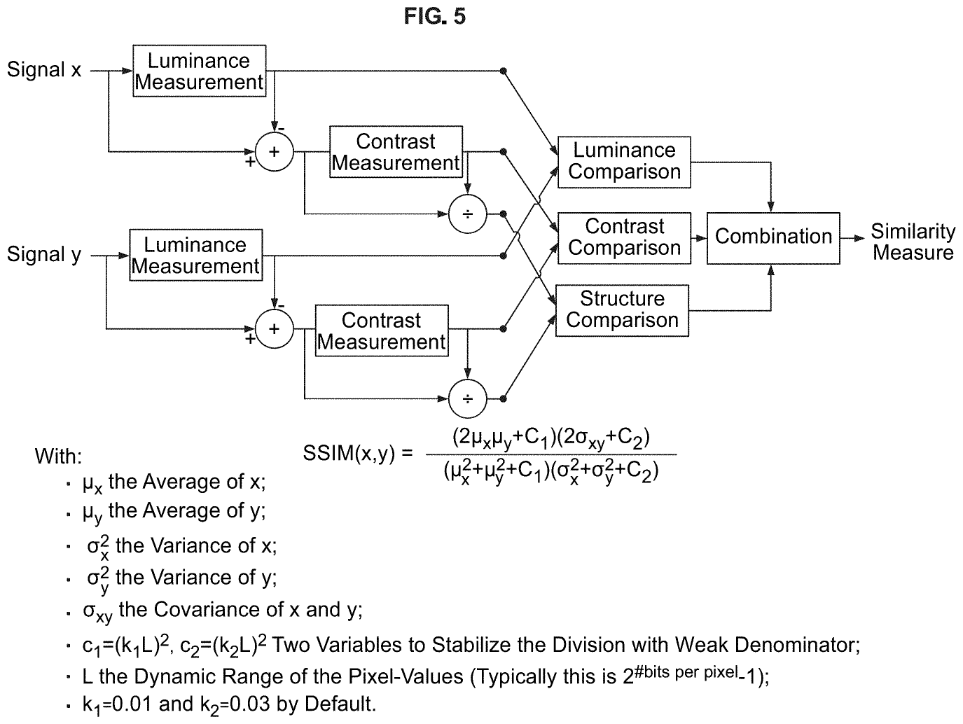

FIG. 5 illustrates calculation of an SSIM index between two windows x and y having common dimensions. The window x may correspond to a frame of a promo end page, and the window y may correspond to a respective frame of reference end page identified at block 413 of FIG. 4. The calculation of FIG. 5 may be applied on luma, on color (e.g., RGB) values or on chromatic (e.g. YCbCr) values. The resultant SSIM index is a decimal value between 0 and 1, where the value of 1 corresponds to a case of two identical sets of data and therefore indicates perfect structural similarity. In contrast, a value of 0 indicates no structural similarity. According to at least one embodiment, if the SSIM index calculated between respective frames of two end pages is approximately equal to (or sufficiently close to) a particular value (e.g., 1), then it is determined that the frames are sufficiently similar.

According to a further embodiment, a reference end page is determined to be sufficiently similar to a promo end page if the SSIM-based criterion described above is met for each of a percentage of pairs of frames. For example, if a particular number of pairs of frames do not satisfy the SSIM-based criterion and all other pairs of frames do satisfy the criterion, then the reference end page is determined to be sufficiently similar to the promo end page. Such a determination is presented in the following pseudo code:

If all(V/T>=T for V in R[:N]) and all(V>=T for V in R[N:]): Success!

In the above pseudo code, R denotes a sorted list of SSIM values from lowest to highest, V denotes the value of a single item in R, T denotes the minimum value of V to be considered a match, N denotes the number of frames that are allowed to be below T in absolute value, :N denotes all items in the list between 0 and N−1, and N: denotes all items between N and the end of the list.

At block 430, the name of the promo end page is analyzed (e.g., with respect to the name(s) of one or more reference end pages identified at block 414). For example, it is determined whether the fields of the name of the promo end page (see FIG. 2) are consistent with the names of the identified reference end pages.

According to at least one embodiment, the quality control process of FIG. 4 may include performing audio validation 450. As illustrated in FIG. 4, the audio validation 450 may be performed after the video validation 410. However, it is understood that the video validation 410 and the audio validation 450 may be performed independent (or irrespective) of each other. For example, the validations 410 and 450 can be performed in parallel.

At block 460, a report is generated. For example, the report may be for storage in a “pass” folder (or directory) if the promo meets all criteria described earlier. Alternatively, the report may be for storage in a quarantine folder and, therefore, flagged for subsequent review (e.g., human review). In an aspect, the report may be generated for monitoring/debugging, and the promo may be moved either to the pass folder or to the quarantine folder. The label for the reference end page may include the MATID data from block 430 that may be used for filename verification and as a pointer to associated audio data, if any.

Returning to block 450, an audio validation 450 will now be described in more detail according to at least one embodiment.

Examples of audio verification according to at least one embodiment will now be described in more detail. In this regard, it is determined whether audio content (e.g., spectral content of an audio signal) of a promo end page matches corresponding audio content of a reference end page. Examples will be described with reference to audio content of the promo end page that includes voiceover audio. The voiceover audio may be similar to that which was described earlier with reference to FIG. 1 (e.g., “Catch Rachael tomorrow at 2 PM on NBC 10 Boston”). Also, examples will be described with reference to audio signals that are stereo signals, in that each given audio signal carries two individual channels (e.g., left channel and right channel).

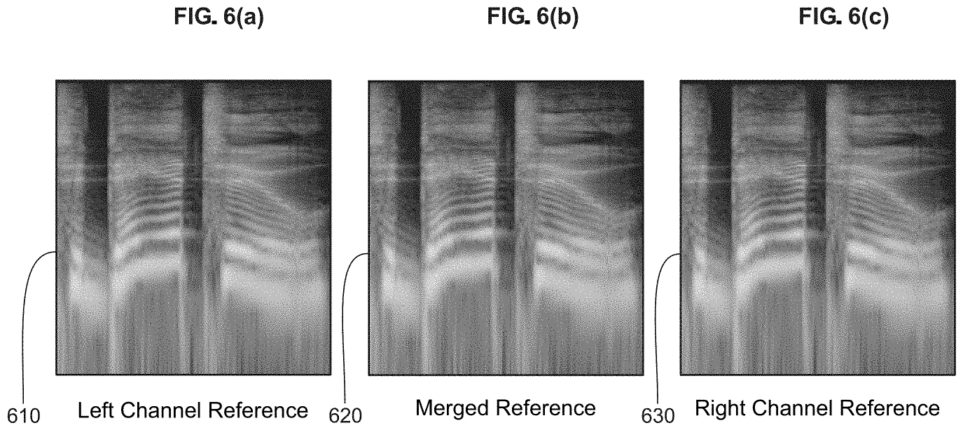

FIGS. 6(a), 6(b) and 6(c) illustrate example spectrograms of audio content in the reference end page. Each spectrogram is a visual representation of the spectrum of frequencies (see vertical axis) in one or more channels of the audio signal as the signal varies over time (see horizontal axis). More particularly, FIG. 6(a) illustrates a spectrogram 610 of the left channel of the audio signal in the reference end page. FIG. 6(c) illustrates a spectrogram 630 of the right channel of the audio signal in the reference end page. FIG. 6(b) illustrates a spectrogram 620 of the merged left and right channels of the audio signal in the reference end page. In an aspect, the left and right channels are merged by mixing the channels together to produce a mono audio track.

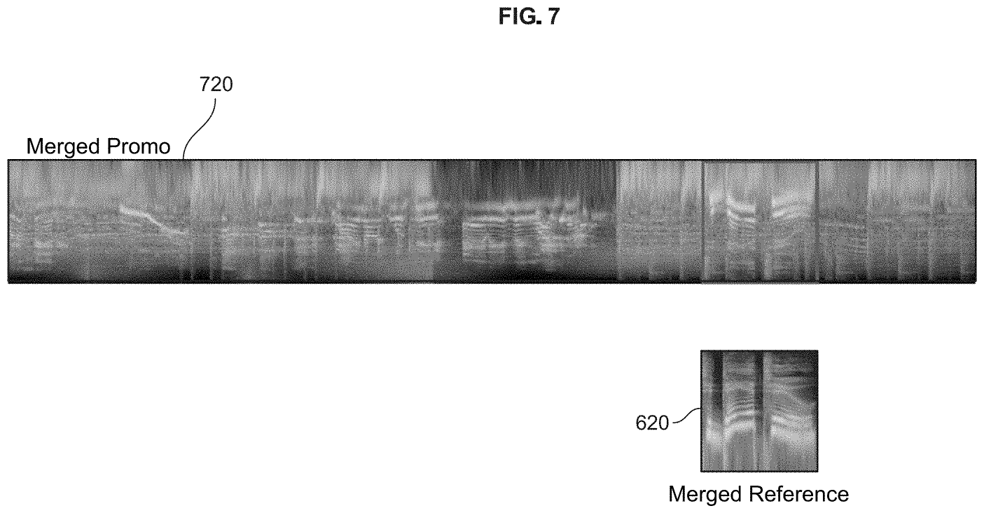

Spectrograms similar to those illustrated in FIGS. 6(a), 6(b) and 6(c) are also obtained for audio content in the promo end page. For example, a spectrogram 720 of merged left and right channels of an audio signal in the promo end page is illustrated in FIG. 7.

FIG. 7 illustrates an example of aligning a spectrogram of audio content in the reference end page with a spectrogram of audio content in the promo end page according to at least one embodiment. For example, an attempt is made to align the spectrogram 620 of audio content (merged left and right channels) in the reference end page. The alignment is performed to obtain an approximate match (e.g., closest match) between the spectrogram 620 and a segment of the spectrogram 720. If the alignment succeeds, then further analysis may be performed based on the spectrogram 620, corresponding to the reference end page, and the matching segment of the spectrogram 720, corresponding to the promo end page.

According to at least one embodiment, the spectrogram 620 may be effectively positioned (or shifted) along the horizontal axis with respect to the spectrogram 720, to obtain a best (or closest) match in spectral content between the spectrograms 620 and 720. Once a best match is obtained, then one or more parameters may be captured to record a location (or positioning) of the alignment.

According to at least one embodiment, the spectrograms 620 and 720 are aligned by calculating a homography that maps the first spectrogram 620 to the segment of the spectrogram 720. Once a best match is obtained, then one or more parameters may be captured to record a horizontal offset of a positioning of the spectrogram 620 with respect to (e.g., within the bounds of) the spectrogram 720. For example, the parameters may include a number in an upper right of a homography matrix.

Such an offset may then be used to effectively crop spectrograms of the promo end page. For example, such an offset may be applied to a spectrogram of the left channel of the audio signal of the promo end page, to crop the spectrogram. Similarly, the offset may be applied to a spectrogram of the right channel of the audio signal of the promo end page. In this manner, the spectrogram of the left channel and the spectrogram of the right channel of the promo end page are cropped to have lengths in time that correspond to the lengths of spectrograms 610 and 630 (see FIGS. 6(a) and 6(c)).

To further analyze similarities/differences between audio content of the promo end page and that of the reference end page, spectrograms of the promo end page are combined with corresponding spectrograms of the reference end page. In an aspect, in the spectrograms are combined by putting one spectrogram on top of another spectrogram to produce a combined spectrogram corresponding to a new audio track with two channels, each channel occupying a separate color channel in the spectrogram image.

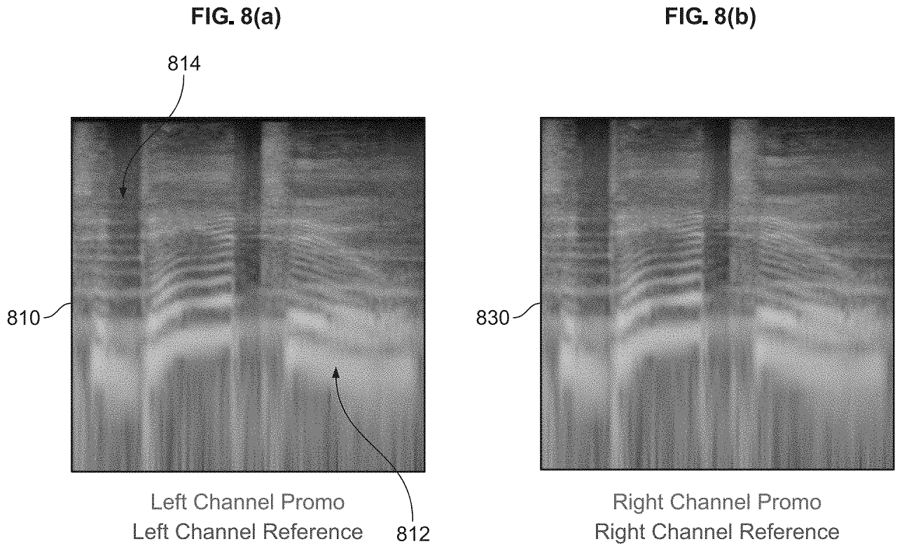

For example, the cropped spectrogram of the left channel of the promo end page is combined with the spectrogram 610 of the left channel of the audio signal in the reference end page in FIG. 6(a). In this regard, the cropped spectrogram of the left channel of the promo end page may be effectively overlaid (or superimposed) over the spectrogram 610. The overlaying produces a combined spectrogram (e.g., combined spectrogram 810 of FIG. 8(a)).

Similarly, the cropped spectrogram of the right channel of the promo end page is combined with the spectrogram 630 of the right channel of the audio signal in the reference end page of FIG. 6(c). In this regard, the cropped spectrogram of the right channel of the promo end page may be effectively overlaid (or superimposed) over the spectrogram 630. The overlaying produces a combined spectrogram (e.g., combined spectrogram 830 of FIG. 8(b)).

According to at least one embodiment, coloring is applied to individual spectrograms before overlaying, such that the combination produces a spectrogram that is generated as a color image.

This will now be described in more detail with reference to the combined spectrogram 810 of FIG. 8(a). As described earlier, the combined spectrogram 810 is produced by combining the cropped spectrogram of the left channel of the promo end page with the spectrogram 610 of FIG. 6(a).

According to at least one embodiment, coloring is applied to the cropped spectrogram of the left channel of the promo end page, such that all audio content in the spectrogram is placed in a first color channel (e.g., a green channel). As such, all spectral content that arises from audio in the cropped spectrogram of the left channel of the promo end page is represented using the color green. The represented audio may include both voiceover audio and background music, as well as other types of audio content.

In addition, a different coloring is applied to the spectrogram 610, which corresponds to the left channel of the reference end page. For example, all audio content in the spectrogram 610 is placed in a second color channel that is different from the first color channel noted above. By way of example, the second color channel may be a red channel. As such, all spectral content that arises from audio in the spectrogram 610 is represented using the color red. The represented audio typically includes voiceover audio but not background music, because the reference end page includes voiceover audio but does not include background music.

The application of coloring to the individual spectrograms results in potentially combined coloring in the combined spectrogram 810. The combined coloring may be utilized to identify areas of alignment (or, conversely, non-alignment) between the reference end page and the promo end page. In more detail, it may be determined whether audio content (e.g., voiceover audio) in the reference end page is also present in the promo end page

For example, if the voiceover audio content in the reference end page aligns with (e.g., matches or is identical to) the voiceover audio content in the promo end page, then regions of a combined color (e.g., yellow) would appear in the RGB image of the combined spectrogram 810. In this situation, yellow is the combined color because the colors red and green combine to produce the color yellow. The yellow-colored regions result from voiceover audio in the cropped spectrogram of the left channel of the promo end page (represented using the color green) being effectively overlaid or superimposed over matching voiceover audio in the spectrogram 610 (represented using the color red). With reference to FIG. 8(a), the region 812 is an example of a region where voiceover audio in the cropped spectrogram of the left channel of the promo end page and voiceover audio in the spectrogram 610 align to appear as a yellow-colored region.

If audio content in the promo end page does not align with audio content in the reference end page, then regions of the first color (e.g., green) may appear in the RGB image of the combined spectrogram 810. As described earlier, spectral content that arises from background music in the promo end page is represented using the color green. The background music may be unique to this specific promo end page, in that different promo end pages may feature different background music and the reference end page does not feature any background music. With reference to FIG. 8(a), the region 814 is an example of a region where background music in the cropped spectrogram of the left channel of the promo end page does not align with any audio content in the spectrogram 610. Accordingly, the corresponding, green-colored region does not overlap with a red-color region in the spectrogram 610, and, therefore, remains green in the combined spectrogram 810.

If audio content in the reference end page does not align with audio content in the promo end page, then regions of the second color (e.g., red) may appear in the RGB image of the combined spectrogram (e.g., combined spectrogram 810). As described earlier, spectral content that arises from all audio content in the reference end page is represented using the color red.

According to at least one embodiment, after such a misalignment between the reference end page and the promo end page is identified, a corresponding time range of the misalignment is recorded. For example, one or more timestamps marking a beginning (or start) and/or an end of misalignment with respect to time may be recorded. Information including such timestamps may be provided.

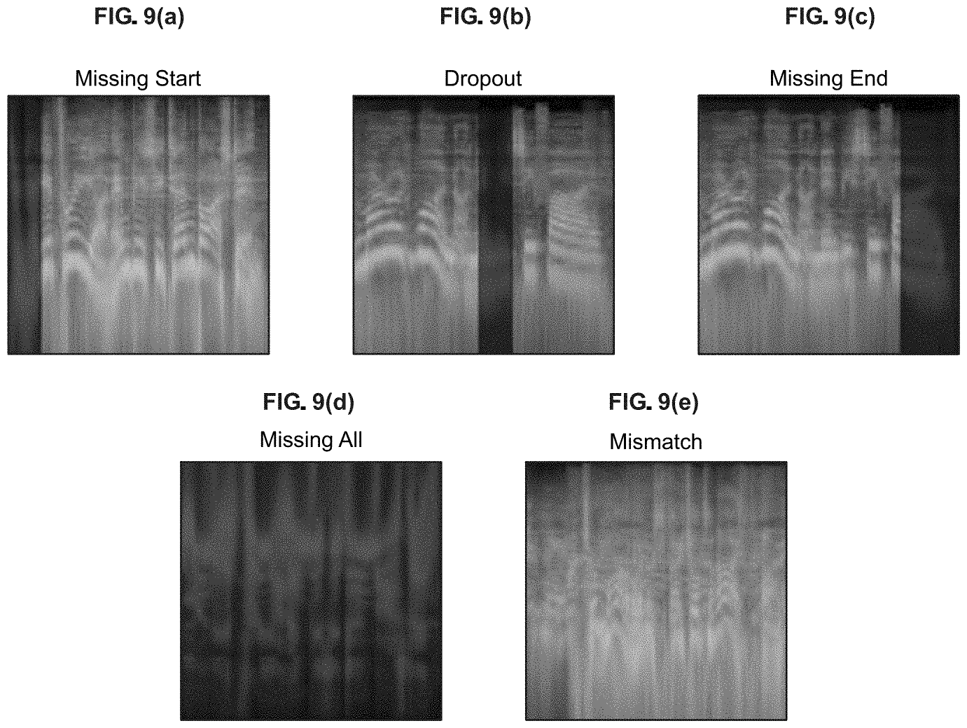

FIG. 9(a) illustrates an example of misalignment at a beginning of the end pages. Here, it is possible that voiceover audio that is present at a beginning of the reference end page is not present at a beginning of the promo end page. Accordingly, a red-colored region appears at a left (starting) area of the combined spectrogram.

FIG. 9(b) illustrates an example of misalignment at (or around) a middle of the end pages. Here, it is possible that voiceover audio that is present at a middle of the reference end page is not present at a middle of the promo end page. Accordingly, a red-colored region appears at a center area of the combined spectrogram.

FIG. 9(c) illustrates an example of misalignment at an end of the end pages. Here, it is possible that voiceover audio that is present at an end of the reference end page is not present at the end of the promo end page. Accordingly, a red-colored region appears at a right (ending) area of the combined spectrogram.

FIG. 9(d) illustrates an example of a complete (or near complete) misalignment between the end pages over time. Here, it is possible that voiceover audio that is present in the reference end page is simply not present in the promo end page. Accordingly, a red-colored region appears throughout the combined spectrogram.

FIG. 9(e) illustrates an example of isolated (or scattered) misalignment between the end pages over time. Here, voiceover audio in the promo end page may not fully match voiceover audio in the reference end page. Accordingly, scattered red-colored regions appear across the combined spectrogram.

According to at least one embodiment, one or more tools based on machine learning may be utilized to determine whether the reference end page passes or fails with respect to the promo end page. The determination may be based, at least in part, on the presence of red-colored regions in the combined spectrogram. For example, if the (combined) size of red-colored regions is under a particular threshold size, then it may be determined that the reference end page sufficiently matches the promo end page. Otherwise, it may be determined that the reference end page does not sufficiently match the promo end page.

According to at least one embodiment, automatic speech recognition (ASR) may be used to eliminate (or reduce) false positives that may arise. For example, audio content in promo end pages may intentionally be sped up or modified slightly to meet on-air requirements. Such changes to the audio content may result in identification of areas of misalignment (or non-alignment) during the audio validation that has been described herein with reference to one or more embodiments. In this regard, ASR-based tools may be used to confirm that the voiceover audio in the reference end page is identical (e.g., in substance) to the voiceover audio in the promo end page. For example, ASR-based tools may be used to confirm that the substance of the voiceover audio in the reference end page matches that of the voiceover audio in the promo end page, which states “Catch Rachael tomorrow at 2 PM on NBC 10 Boston” (see the example described earlier with reference to FIG. 1). Accordingly, the number of false positives may be reduced.

It is understood that coloring aspects in the combined spectrogram 830 of FIG. 8(b) are similar to those described earlier with reference to the combined spectrogram 810 of FIG. 8(a), as well as those of FIGS. 9(a), 9(b), 9(c), 9(d) and 9(e). Accordingly, for purposes of brevity, the coloring aspects in the combined spectrogram 830 of FIG. 8(b) will not be described in more detail below. Further, although red, yellow, and green were chosen in the examples to provide color to the audio channels and to the combined spectrograms, other colors may be used, and the techniques are not limited to a particular color scheme.

As described herein, one or more embodiments are directed to comparing aspects of a reference end page and aspects of a promo end page. The aspects may relate to video content of the end pages. Alternatively (or in addition), the aspects may relate to audio content of the end pages. As described earlier with respect to at least one embodiment, it is determined whether specific audio content (e.g., voiceover content) that is present in the reference end page is also present in the promo end page. However, it is understood that the specific audio content may be audio content that is not language-based. For example, it may be determined whether specific tone-based content (e.g., a sequence of chimes or musical tones) that is present in the reference end page is also present in the promo end page.

Also, it is understood that features described herein may be utilized to determine whether an audio layout of the reference end page sufficiently matches an audio layout of the promo end page. The audio layout may relate to a balance between left and right channels.

Based on features that have been described herein, particular audio content (e.g., voiceover content) may be isolated within a larger audio scape (e.g., a promo end page that includes not only the voiceover content but also other forms of audio content such as background music). As such, comparison of the promo end page with a reference end page that includes no background music is facilitated. Such a feature serves to distinguish embodiments described herein from an approach that is based merely on analysis of raw audio bytes and that does not serve to isolate a specific type of audio content (e.g., voiceover content) from a different type of audio content (e.g., background music).

In addition, features described herein are distinguishable from approaches that determine audio similarity, for example, based on an audio “fingerprint” that records audio frequencies having largest energies at respective points in time. Such approaches do not utilize, for example, analysis of RGB images such as those described earlier with reference to combined spectrograms 810 and 830.

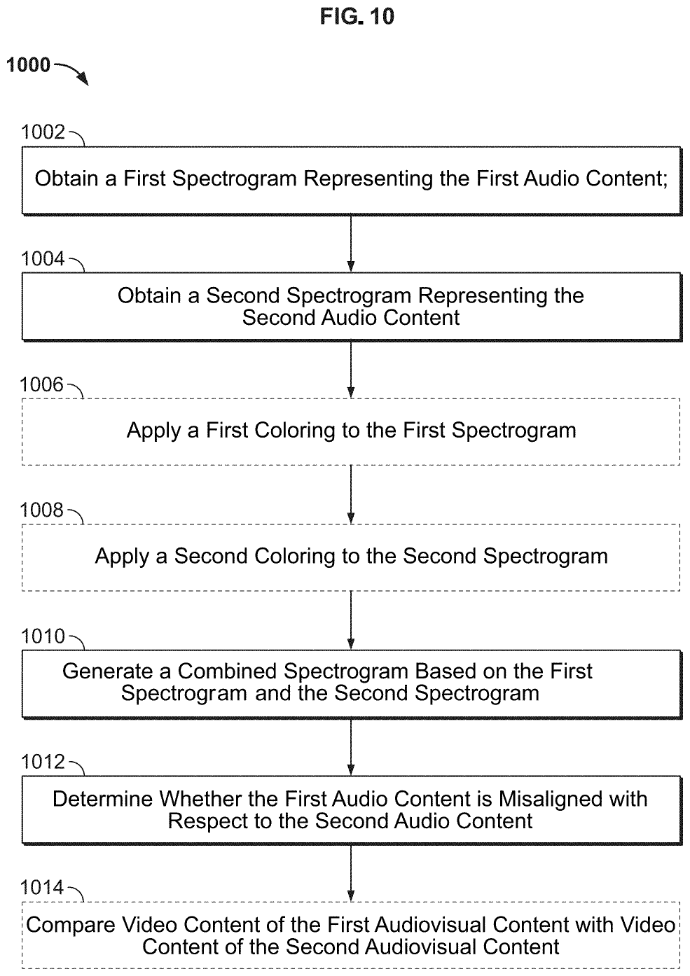

FIG. 10 illustrates a flowchart of a method 1000 of comparing a first audio content with a second audio content according to at least one embodiment.

At block 1002, a first spectrogram representing the first audio content is obtained. The first audio content may be part of a first audiovisual content that includes a reference end page.

For example, with reference to FIG. 6(a), a spectrogram 610 of a left channel of an audio signal in a reference end page is obtained. Alternatively (or in addition), with reference to FIG. 6(c), a spectrogram 630 of a right channel of the audio signal in the reference end page is obtained.

At block 1004, a second spectrogram representing the second audio content is obtained. The second audio content may be part of a second audiovisual content that includes a promo end page.

For example, as described earlier with reference to FIG. 7, an offset may be applied to a spectrogram of a left channel (or a right channel) of an audio signal of a promo end page, to crop the spectrogram. Similarly, the offset may be applied to a spectrogram of the right channel of the audio signal of the promo end page. In this manner, the spectrogram of the left channel and the spectrogram of the right channel of the promo end page are cropped to have lengths in time that correspond to the lengths of spectrograms 610 and 630 (see FIGS. 6(a) and 6(c)).

In an aspect, the second spectrogram is obtained based on a homography that maps the first spectrogram to a segment of a spectrogram representing the second audio content.

For example, as described earlier with reference to FIG. 7, a homography that maps the spectrogram 620 to a segment of the spectrogram 720 is calculated.

In another aspect, obtaining the second spectrogram includes aligning the first spectrogram to obtain an approximate match between the first spectrogram and a segment of a spectrogram representing the second audio content.

For example, as described earlier with reference to FIG. 7, an attempt is made to align the spectrogram 620 of audio content (merged left and right channels) in the reference end page. The alignment is performed to obtain an approximate match (e.g., closest match) between the spectrogram 620 and a segment of the spectrogram 720.

At block 1006, a first coloring may be applied to the first spectrogram.

For example, as described earlier, all audio content in the spectrogram 610 is placed in a particular color channel (e.g., a red channel).

At block 1008, a second coloring may be applied to the second spectrogram.

For example, as described earlier, coloring is applied to the cropped spectrogram of the left channel of the promo end page, such that all audio content in the spectrogram is placed in a particular color channel (e.g., a green channel).

At block 1010, a combined spectrogram is generated based on the first spectrogram and the second spectrogram.

According to a further embodiment, generating the combined spectrogram includes generating a combined spectrogram by superimposing one of the first spectrogram or the second spectrogram over the other.

For example, as described earlier with reference to FIG. 8(a), the cropped spectrogram of the left channel of the promo end page may be effectively overlaid (or superimposed) over the spectrogram 610. The overlaying produces a combined spectrogram (e.g., combined spectrogram 810 of FIG. 8(a)).

At block 1012, it is determined whether the first audio content is misaligned with respect to the second audio content based on the combined spectrogram.

According to a further embodiment, determining whether the first audio content is misaligned with respect to the second audio content is based on a presence of a third coloring in the combined spectrogram, the third coloring corresponding to a combination of the first coloring and the second coloring.

For example, as described earlier with reference to FIG. 8(a), if the voiceover audio content in the reference end page aligns with (e.g., matches or is identical to) the voiceover audio content in the promo end page, then regions of a combined color (e.g., yellow) would appear in the RGB image of the combined spectrogram 810. In this situation, yellow is the combined color because the colors red and green combine to produce the color yellow.

According to a further embodiment, determining whether the first audio content is misaligned with respect to the second audio content includes identifying a misalignment between the first audio content and the second audio content, and recording a corresponding time range of the misalignment.

For example, as described earlier with reference to FIG. 9(a), an example of a misalignment at a beginning of the end pages is identified. In this regard, a time range of the misalignment (e.g., a range in time over which the misalignment occurs) may be recorded. In an aspect, the time range of the misalignment may be used to calculate a percentage of misalignment based on the time range of the spectrogram.

At block 1014, video content of the first audiovisual content may be compared with video content of the second audiovisual content.

In an aspect, comparing the video content of the first audiovisual content with the video content of the second audiovisual content is based on perceptual hashing.

For example, as described earlier with reference to FIG. 4, a video validation 410 may include generating a hash of the promo is generated. According to at least one embodiment, the hash may be generated based on perceptual hashing.

In at least some embodiments, features described herein, or other aspects of the disclosure (e.g., the method 1000 of FIG. 10) may be implemented and/or performed at one or more software or hardware computer systems which may further include (or may be operably coupled to) one or more hardware memory systems for storing information including databases for storing, accessing, and querying various content, encoded data, shared addresses, metadata, etc. In hardware implementations, the one or more computer systems incorporate one or more computer processors and controllers.

The components of various embodiments described herein may each include a hardware processor of the one or more computer systems, and, in one embodiment, a single processor may be configured to implement the various components. For example, in one embodiment, the encoder, the content server, and the web server, or combinations thereof, may be implemented as separate hardware systems, or may be implemented as a single hardware system. The hardware system may include various transitory and non-transitory memory for storing information, wired and wireless communication receivers and transmitters, displays, and input and output interfaces and devices. The various computer systems, memory, and components of the system may be operably coupled to communicate information, and the system may further include various hardware and software communication modules, interfaces, and circuitry to enable wired or wireless communication of information.

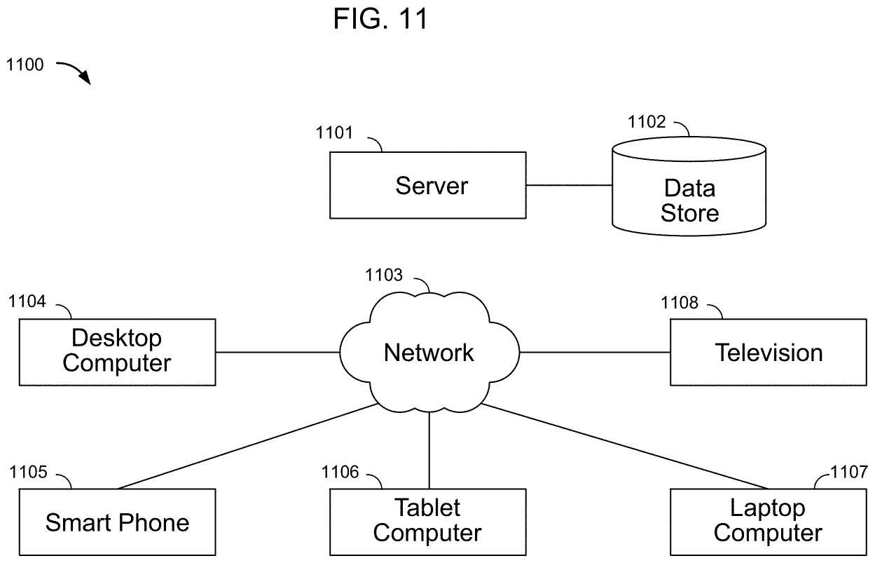

In selected embodiments, features and aspects described herein may be implemented within a computing environment 1100, as shown in FIG. 11, which may include one or more computer servers 1101. The server 1101 may be operatively coupled to one or more data stores 1102 (for example, databases, indexes, files, or other data structures). The server 1101 may connect to a data communication network 1103 including a local area network (LAN), a wide area network (WAN) (for example, the Internet), a telephone network, a satellite or wireless communication network, or some combination of these or similar networks.

One or more client devices 1104, 1105, 1106, 1107, 1108 may be in communication with the server 1101, and a corresponding data store 1102 via the data communication network 1103. Such client devices 1104, 1105, 1106, 1107, 1108 may include, for example, one or more laptop computers 1107, desktop computers 1104, smartphones and mobile phones 1105, tablet computers 1106, televisions 1108, or combinations thereof. In operation, such client devices 1104, 1105, 1106, 1107, 1108 may send and receive data or instructions to or from the server 1101 in response to user input received from user input devices or other input. In response, the server 1101 may serve data from the data store 1102, alter data within the data store 1102, add data to the data store 1102, or the like, or combinations thereof.

In selected embodiments, the server 1101 may transmit one or more media files including audio and/or video content, encoded data, generated data, and/or metadata from the data store 1102 to one or more of the client devices 1104, 1105, 1106, 1107, 1108 via the data communication network 1103. The devices may output the audio and/or video content from the media file using a display screen, projector, or other display output device. In certain embodiments, the system 1100 configured in accordance with features and aspects described herein may be configured to operate within or support a cloud computing environment. For example, a portion of, or all of, the data store 1102 and server 1101 may reside in a cloud server.

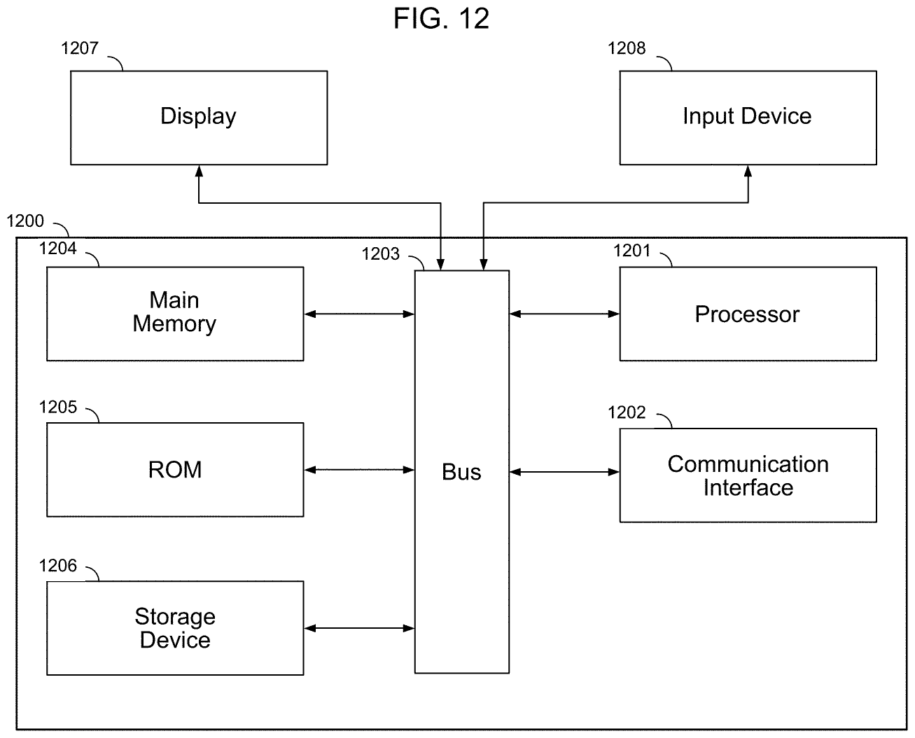

With reference to FIG. 12, an illustration of an example computer 1200 is provided. One or more of the devices 1104, 1105, 1106, 1107, 1108 of the system 1100 may be configured as or include such a computer 1200.

In selected embodiments, the computer 1200 may include a bus 1203 (or multiple buses) or other communication mechanism, a processor 1201, main memory 1204, read only memory (ROM) 1205, one or more additional storage devices 1206, and/or a communication interface 1202, or the like or sub-combinations thereof. Embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

The bus 1203 or other communication mechanism, including multiple such buses or mechanisms, may support communication of information within the computer 1200. The processor 1201 may be connected to the bus 1203 and process information. In selected embodiments, the processor 1201 may be a specialized or dedicated microprocessor configured to perform particular tasks in accordance with the features and aspects described herein by executing machine-readable software code defining the particular tasks. Main memory 1204 (for example, random access memory—or RAM—or other dynamic storage device) may be connected to the bus 1203 and store information and instructions to be executed by the processor 1201. Main memory 1204 may also store temporary variables or other intermediate information during execution of such instructions.

ROM 1205 or some other static storage device may be connected to a bus 1203 and store static information and instructions for the processor 1201. The additional storage device 1206 (for example, a magnetic disk, optical disk, memory card, or the like) may be connected to the bus 1203. The main memory 1204, ROM 1205, and the additional storage device 1206 may include a non-transitory computer-readable medium holding information, instructions, or some combination thereof—for example, instructions that, when executed by the processor 1201, cause the computer 1200 to perform one or more operations of a method as described herein. The communication interface 1202 may also be connected to the bus 1203. A communication interface 1202 may provide or support two-way data communication between the computer 1200 and one or more external devices (for example, other devices contained within the computing environment).

In selected embodiments, the computer 1200 may be connected (for example, via the bus 1203) to a display 1207. The display 1207 may use any suitable mechanism to communicate information to a user of a computer 1200. For example, the display 1207 may include or utilize a liquid crystal display (LCD), light emitting diode (LED) display, projector, or other display device to present information to a user of the computer 1200 in a visual display. One or more input devices 1208 (for example, an alphanumeric keyboard, mouse, microphone) may be connected to the bus 1203 to communicate information and commands to the computer 1200. In selected embodiments, one input device 1208 may provide or support control over the positioning of a cursor to allow for selection and execution of various objects, files, programs, and the like provided by the computer 1200 and displayed by the display 1207.

The computer 1200 may be used to transmit, receive, decode, display, etc. one or more video files. In selected embodiments, such transmitting, receiving, decoding, and displaying may be in response to the processor 1201 executing one or more sequences of one or more instructions contained in main memory 1204. Such instructions may be read into main memory 1204 from another non-transitory computer-readable medium (for example, a storage device).

Execution of sequences of instructions contained in main memory 1204 may cause the processor 1201 to perform one or more of the procedures or steps described herein. In selected embodiments, one or more processors in a multi-processing arrangement may also be employed to execute sequences of instructions contained in main memory 1204. Alternatively, or in addition thereto, firmware may be used in place of, or in connection with, software instructions to implement procedures or steps in accordance with the features and aspects described herein. Thus, embodiments in accordance with features and aspects described herein may not be limited to any specific combination of hardware circuitry and software.

Non-transitory computer readable medium may refer to any medium that participates in holding instructions for execution by the processor 1201, or that stores data for processing by a computer, and include all computer-readable media, with the sole exception being a transitory, propagating signal. Such a non-transitory computer readable medium may include, but is not limited to, non-volatile media, volatile media, and temporary storage media (for example, cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, the communication interface 1202 may provide or support external, two-way data communication to or via a network link. For example, the communication interface 1202 may be a wireless network interface controller or a cellular radio providing a data communication network connection. Alternatively, the communication interface 1202 may include a LAN card providing a data communication connection to a compatible LAN. In any such embodiment, the communication interface 1202 may send and receive electrical, electromagnetic, or optical signals conveying information.

A network link may provide data communication through one or more networks to other data devices (for example, client devices as shown in the computing environment 1100). For example, a network link may provide a connection through a local network of a host computer or to data equipment operated by an Internet Service Provider (ISP). An ISP may, in turn, provide data communication services through the Internet. Accordingly, a computer 1200 may send and receive commands, data, or combinations thereof, including program code, through one or more networks, a network link, and communication interface 1202. Thus, the computer 1200 may interface or otherwise communicate with a remote server (for example, server 1101), or some combination thereof.

The various devices, modules, terminals, and the like described herein may be implemented on a computer by execution of software comprising machine instructions read from computer-readable medium, as discussed above. In certain embodiments, several hardware aspects may be implemented using a single computer; in other embodiments, multiple computers, input/output systems and hardware may be used to implement the system.

For a software implementation, certain embodiments described herein may be implemented with separate software modules, such as procedures and functions, each of which performs one or more of the functions and operations described herein. The software codes can be implemented with a software application written in any suitable programming language and may be stored in memory and executed by a controller or processor.

The foregoing described embodiments and features are merely exemplary and are not to be construed as limiting the present invention. The present teachings can be readily applied to other types of apparatuses and processes. The description of such embodiments is intended to be illustrative, and not to limit the scope of the claims. Many alternatives, modifications, and variations will be apparent to those skilled in the art.

What is claimed is:

1. A method for comparing a first audio content with a second audio content, the method comprising:
obtaining a first spectrogram representing the first audio content;
obtaining a second spectrogram representing the second audio content;
generating a combined spectrogram based on the first spectrogram and the second spectrogram; and
determining whether the first audio content is misaligned with respect to the second audio content based on the combined spectrogram.

2. The method of claim 1, wherein the second spectrogram is obtained based on a homography that maps the first spectrogram to a segment of a spectrogram representing the second audio content.

3. The method of claim 1, wherein obtaining the second spectrogram comprises aligning the first spectrogram to obtain an approximate match between the first spectrogram and a segment of a spectrogram representing the second audio content.

4. The method of claim 1, wherein:
the first audio content is part of a first audiovisual content that comprises a reference end page; and
the second audio content is part of a second audiovisual content that comprises a promo end page.

5. The method of claim 4, further comprising:
comparing video content of the first audiovisual content with video content of the second audiovisual content.

6. The method of claim 5, wherein comparing the video content of the first audiovisual content with the video content of the second audiovisual content is based on perceptual hashing.

7. The method of claim 1, wherein determining whether the first audio content is misaligned with respect to the second audio content comprises at least one of:
identifying a misalignment at a beginning of the combined spectrogram with respect to time;
identifying a misalignment at or around a middle of the combined spectrogram with respect to time;
identifying a misalignment at an end of the combined spectrogram with respect to time;
identifying a complete misalignment across the combined spectrogram with respect to time; or
identifying a plurality of scattered misalignments across the combined spectrogram with respect to time.

8. The method of claim 1, further comprising:
applying a first coloring to the first spectrogram;
applying a second coloring to the second spectrogram; and
generating the combined spectrogram comprises superimposing one of the first spectrogram or the second spectrogram over the other,
wherein determining whether the first audio content is misaligned with respect to the second audio content is based on a presence of a third coloring in the combined spectrogram, the third coloring corresponding to a combination of the first coloring and the second coloring.

9. The method of claim 1, wherein determining whether the first audio content is misaligned with respect to the second audio content is performed using a machine learning model.

10. The method of claim 1, wherein determining whether the first audio content is misaligned with respect to the second audio content comprises:
identifying a misalignment between the first audio content and the second audio content; and
recording a corresponding time range of the misalignment.

11. A machine-readable non-transitory medium having stored thereon machine-executable instructions for comparing a first audio content with a second audio content, the instructions comprising:
obtaining a first spectrogram representing the first audio content;
obtaining a second spectrogram representing the second audio content;
generating a combined spectrogram based on the first spectrogram and the second spectrogram; and
determining whether the first audio content is misaligned with respect to the second audio content based on the combined spectrogram.

12. The machine-readable non-transitory medium of claim 11, wherein the second spectrogram is obtained based on a homography that maps the first spectrogram to a segment of a spectrogram representing the second audio content.

13. The machine-readable non-transitory medium of claim 11, wherein obtaining the second spectrogram comprises aligning the first spectrogram to obtain an approximate match between the first spectrogram and a segment of a spectrogram representing the second audio content.

14. The machine-readable non-transitory medium of claim 11, wherein:
the first audio content is part of a first audiovisual content that comprises a reference end page; and
the second audio content is part of a second audiovisual content that comprises a promo end page.

15. The machine-readable non-transitory medium of claim 14, wherein the instructions further comprise:
comparing video content of the first audiovisual content with video content of the second audiovisual content.

16. The machine-readable non-transitory medium of claim 15, wherein comparing the video content of the first audiovisual content with the video content of the second audiovisual content is based on perceptual hashing.

17. The machine-readable non-transitory medium of claim 11, wherein determining whether the first audio content is misaligned with respect to the second audio content comprises at least one of:
identifying a misalignment at a beginning of the combined spectrogram with respect to time;
identifying a misalignment at or around a middle of the combined spectrogram with respect to time;
identifying a misalignment at an end of the combined spectrogram with respect to time;
identifying a complete misalignment across the combined spectrogram with respect to time; or
identifying a plurality of scattered misalignments across the combined spectrogram with respect to time.

18. The machine-readable non-transitory medium of claim 11, wherein the instructions further comprise:
applying a first coloring to the first spectrogram;
applying a second coloring to the second spectrogram; and
generating the combined spectrogram comprises superimposing one of the first spectrogram or the second spectrogram over the other,
wherein determining whether the first audio content is misaligned with respect to the second audio content is based on a presence of a third coloring in the combined spectrogram, the third coloring corresponding to a combination of the first coloring and the second coloring.

19. The machine-readable non-transitory medium of claim 11, wherein determining whether the first audio content is misaligned with respect to the second audio content comprises:
identifying a misalignment between the first audio content and the second audio content; and
recording a corresponding time range of the misalignment.

20. An apparatus for comparing a first audio content with a second audio content, the apparatus comprising:
a network communication unit configured to transmit and receive data; and
one or more controllers configured to:
obtain a first spectrogram representing the first audio content;
obtain a second spectrogram representing the second audio content;
generate a combined spectrogram based on the first spectrogram and the second spectrogram; and
determine whether the first audio content is misaligned with respect to the second audio content based on the combined spectrogram.
